(19) United States
(12) Patent Application Publication
(10) Pub. No.: US 2026/0292333 A1
(43) Pub. Date: Sep. 24, 2026

(54) MOBILE DEVICE HOLDER WITH ACTIVATION INTERFACE, RECORDING SYSTEM, AND METHODS FOR THE USE AND ASSEMBLY THEREOF

(71) Applicant: ZAGG Inc, Midvale, UT (US)

(72) Inventors: Margaret Duffy Myers, Salt Lake City, UT (US); Joshua Keith Peterson, Fort Collins, CO (US)

(21) Appl. No.: 19/574,852

(22) Filed: Mar. 23, 2026

Related U.S. Application Data
(60) Provisional application No. 63/776,362, filed on Mar. 24, 2025.

(51) Int. Cl. H04N 23/65; A45C 11/00; A45F 5/00; H04N 23/56; H04N 23/57; H04N 23/661

(52) U.S. Cl. CPC H04N 23/651; A45C 11/002; A45C 11/003; A45F 5/1516; A45F 5/1525; A45F 5/1533; H04N 23/56; H04N 23/57; H04N 23/661; A45F 2005/006

(57) ABSTRACT

A holder for holding and controlling a mobile device capable of capturing an image includes a housing having an activation interface and a connector configured to transmit data and/or power to the mobile device from the holder. A recording system for actuating the camera on the mobile device includes the holder and the mobile device, with the camera of the mobile device facing but not being obscured by the base portion. Methods of using and assembling the system are also provided.

This application claims the benefit of U.S. Provisional Application No. 63/776,362, filed Mar. 24, 2026, and entitled “Mobile Device Holder With Activation Interface, Recording System, and Methods for the Use and Assembly Thereof,” the entire disclosure of which is hereby incorporated herein by reference.

### FIELD OF THE INVENTION

The present application relates generally to a holder for carrying a mobile device, and more specifically to a holder having an activation interface for controlling the mobile device, to systems including the holder and mobile device and to methods for the use and assembly thereof.

### BACKGROUND

Body cameras or quick record devices typically are purpose made devices used solely to record audio and video content. Such devices may be configured with a quick record button and several action buttons that may be programmed for different functions. Such purpose-built devices may have limited functionality. Conversely, while conventional mobile devices, such as smart phones and tablets, may have excellent camera capabilities, the user must typically activate the camera by interfacing directly with the mobile device.

### SUMMARY

The present invention is defined by the following claims, and nothing in this section should be considered to be a limitation on those claims.

In one aspect, one embodiment of a holder for holding and controlling a mobile device capable of capturing an image includes a housing having a base portion, at least one engaging feature and a connector. The base portion includes an activation interface, wherein the base portion is configured to support a rear surface of the mobile device. The at least one engaging feature may extend from the base in a first direction and may be configured to engage one of a side, bottom or top of the mobile device. The connector is configured to transmit data and/or power to the mobile device.

In another aspect, one embodiment of a recording system for actuating the camera on the mobile device includes the holder and the mobile device, wherein the mobile device is engaged by the at least one engaging feature with a rear surface of the mobile device positioned against an interior surface of the base portion. A screen portion of the mobile device faces away from the holding portion, and the camera of the mobile device faces but is not obscured by the base portion.

In yet another aspect, one embodiment of a method of recording a user interaction includes positioning a mobile device having a camera on a holder, wherein the holder and mobile device are in communication, attaching the holder and mobile device camera to the user, actuating an activation interface on the holder; and sending a signal to the mobile device to turn on the camera.

The various embodiments of the holder, system and methods provide significant advantages over other devices. For example and without limitation, the holder and system converts a standard mobile device, i.e. phone or tablet, into a recording device by the activation of the activation interface on the holder. While mobile devices are typically configured with all the necessary features to be a quick record device: a camera, memory, wireless connectivity, microphone and screen to make the device functional as a quick record product, the user must interface directly with the mobile device. The holder has multiple accessories for attachment to the user and/or their clothing. In this way, the user can easily wear and actuate a body camera using the mobile device. The holder supports and protects the mobile device, while also enabling recording, potentially extend battery life, and many other potential related functions.

The foregoing paragraphs have been provided by way of general introduction, and are not intended to limit the scope of the following claims. The various preferred embodiments, together with further advantages, will be best understood by reference to the following detailed description taken in conjunction with the accompanying drawings.

### BRIEF DESCRIPTION OF THE DRAWINGS

FIG. 1 is a perspective view of one embodiment of a holder and mobile device;

FIG. 2 is a view of a holder and mobile device carried by a user;

FIG. 3 is a front view of one embodiment of a holder;

FIG. 4 is a rear view of the holder shown in FIG. 3;

FIG. 5 is a bottom, perspective view of the holder shown in FIG. 3;

FIG. 6 is a bottom, perspective view of the holder and mobile device shown in FIG. 2;

FIG. 7 is a top, perspective view of the holder shown in FIG. 3;

FIG. 8 is a side view of the holder shown in FIG. 3;

FIG. 9 is a front view of the holder and mobile device shown in FIG. 2.

FIG. 10 is a side view of one embodiment of an auxiliary holder carrying the holder and mobile device shown in FIG. 9;

FIG. 11 is a partial, exploded view of the auxiliary holder shown in FIG. 10;

FIG. 12 is a side view of another embodiment of an auxiliary holder carrying the holder and mobile device shown in FIG. 9;

FIG. 13 is a perspective view of a plurality of holders carrying mobile devices positioned in a docking/charging station; and

FIG. 14 is a schematic representation of the recording system.

### DETAILED DESCRIPTION OF THE PRESENTLY PREFERRED EMBODIMENTS

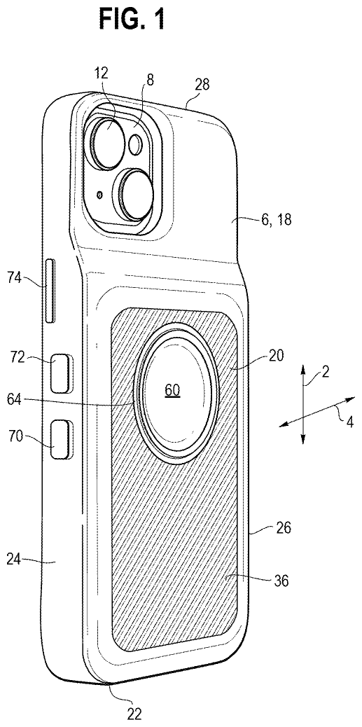

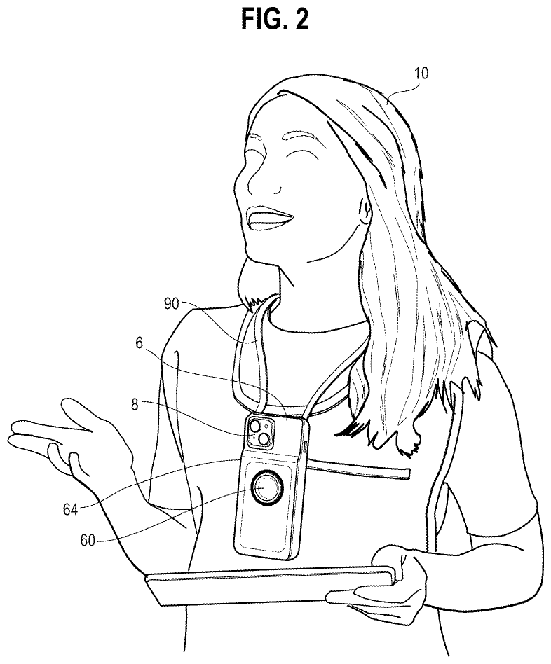

It should be understood that the term “plurality,” as used herein, means two or more. As shown in FIG. 1, the term “longitudinal,” as used herein, means of or relating to a length or lengthwise direction 2, for example a direction running from a top to a bottom of a holder 6 and mobile device 8. The term “lateral,” as used herein, means situated on, directed toward or running in a side-to-side direction 4 of the holder 6 and mobile device 8. The term “coupled” means connected to or engaged with whether directly or indirectly, for example with an intervening member, and does not require the engagement to be fixed or permanent, although it may be fixed or permanent. The term “fixed” means not moveable. The terms “first,” “second,” and so on, as used herein, are not meant to be assigned to a particular component or feature so designated, but rather are simply referring to such components and features in the numerical order as addressed, meaning that a component or feature designated as “first” may later be a “second” such component or feature, depending on the order in which it is referred. It should also be understood that designation of “first” and “second” does not necessarily mean that the two components, features or values so designated are different, meaning for example a first direction may be the same as a second direction, with each simply being applicable to different components or features. The terms “upper,” “lower,” “rear,” “front,” “fore,” “aft,” “vertical,” “horizontal,” and variations or derivatives thereof, refer to the orientations of the exemplary holder 6 and mobile device 8 as shown in FIGS. 1 and 2 from the perspective of a user 10. The phrase “mobile device” refers to a portable recording device, including without limitation smart phones and tablets, and also cameras, which are capable of recording video and audio.

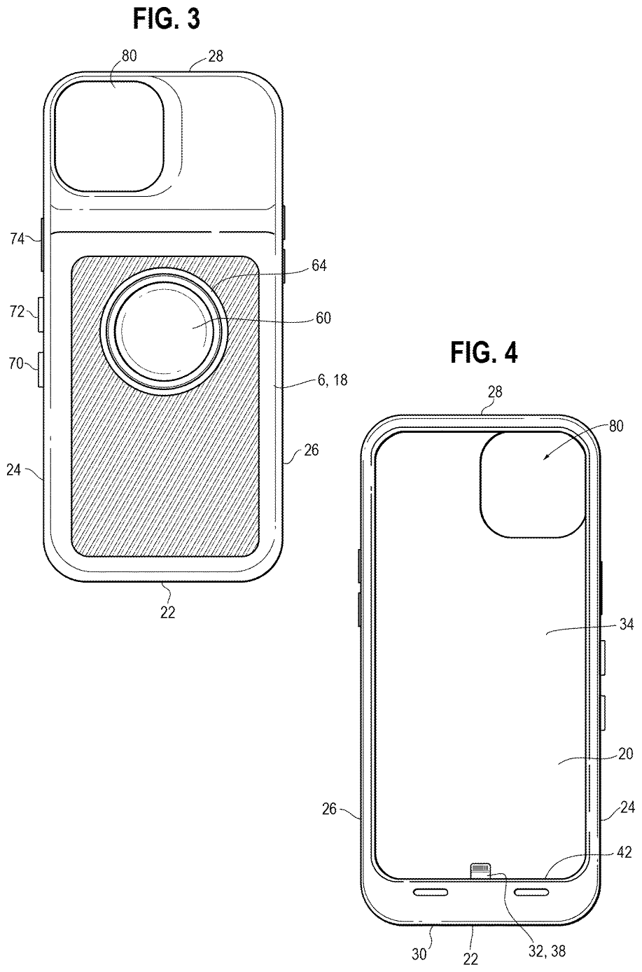

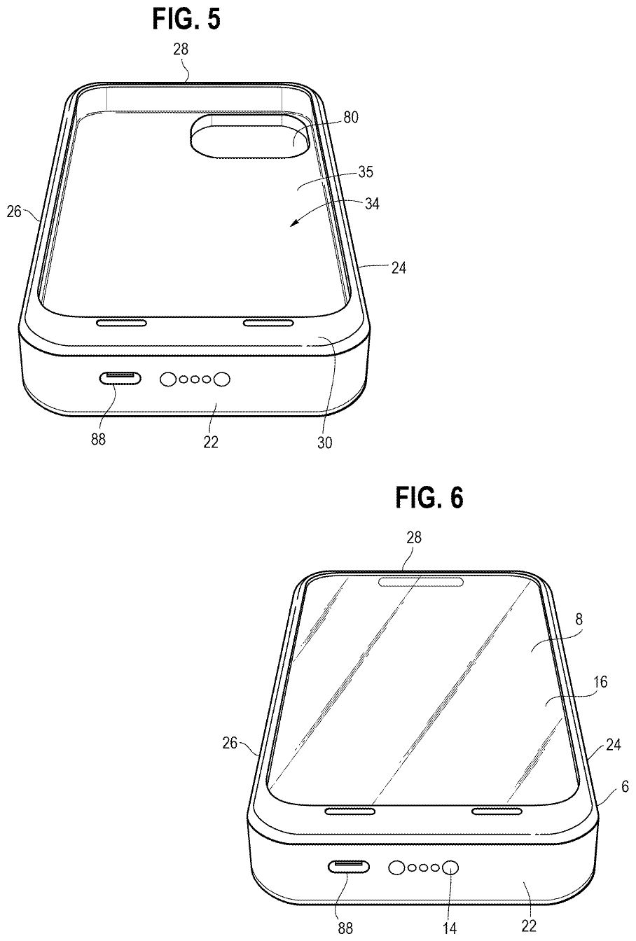

Referring to FIGS. 1-8 and 14, the holder 6 is shown as holding the mobile device 8. In one embodiment, the mobile device 8 includes a camera 12 with a lens and a microphone 14. The mobile device 8 is capable of capturing an image, e.g., still or video, and also audio corresponding to the image. The image and/or audio may be stored on the mobile device 8, and/or transmitted to a storage medium via blue tooth or by way of a transmission line. The camera 12 is typically mounted on a rear surface of the mobile device 8, with the front surface having a screen 16 defining a user interface and/or display as shown in FIG. 6.

The holder 6 includes a housing 18 having a base portion 20, at least one engaging feature 22, 24, 26, 28, 30 and a connector 32. In one embodiment, the engagement feature may include one or more of a bottom wall 22, a pair of laterally spaced side walls 24, 26, a top wall 28 and/or a rear wall 30, which forms a pocket. The holder may be made of various silicone and/or plastic materials. The base portion 20 has a front surface 36 and a rear, interior surface 35 facing and supporting the rear surface of the mobile device 8, which is turned toward the body of the user in this particular application. The engagement features, including the bottom, top, and side walls 22, 24, 26, 28, extend from the base portion 20 in a first direction and overlie and engage the respective bottom, top and side walls of the mobile device 8. One or more of the walls may include a lip that surrounds a portion of the front of the mobile device. The engagement features, including the walls 22, 24, 26, 28, may define a cavity 34 in which the mobile device 8 is received. The term “engagement feature” refers to any component capable of engaging and coupling the mobile device to the holder, and may include the walls, and/or other clips, tabs, snaps, magnets and/or adhesives. In one embodiment, the connector 32 serves as the engagement feature.

In one embodiment, as shown in FIGS. 4, 6 and 14, the connector 32 includes an insert portion 38 extending upwardly from the bottom wall 22 in a second direction and into the cavity 34. In one embodiment, the insert portion 38 is parallel to and spaced apart from the surface 34 of the base portion and the rear wall 30. The connector 32 is configured to transmit data and/or power to the mobile device 8. The connector may be in direct electrical communication with the mobile device, for example by way of the insert portion 38 being received in a connector port 40 of the mobile device when the mobile device 8 is inserted into the cavity 34, with the bottom portion of the mobile device 8 inserted into the pocket 42. The connector 32 may be configured as a USB-C connector, lightening connector, or other connector providing pass-through charging, either from a power source 46 on the holder 6, or from a power source 48 connected to the holder via an auxiliary connector 50. Alternatively, the connector may be a blue tooth transmitter/receiver that communicates with the mobile device via blue tooth and/or an induction charging device.

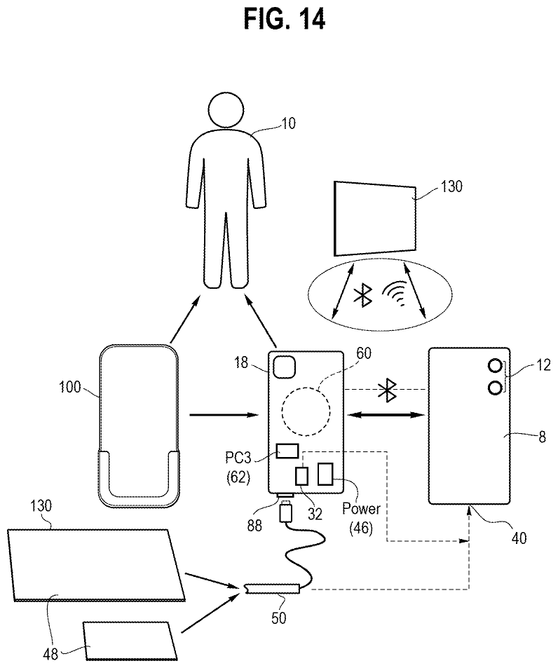

The base portion 20 includes an activation interface 60, which may be configured as a button, lever, toggle or switch. In one embodiment, the activation interface, shown for example in FIG. 1, is configured as a large button, and may be circular, located generally in a central portion of a front surface 36 of the base portion 20, wherein the activation interface 60 may be easily accessed and actuated by pressing the button. Referring to FIG. 14, the holder 6 may include a printed circuit board (PCB) 62 embedded in the housing 18, for example in the base portion. The activation interface 60 is operably connected to the PCB 62, e.g., electrically, with the PCB generating a signal transmitted through the connector 32 to the mobile device 8 to activate, or turn on, the camera 12 and microphone 14. The holder 6 may also include a power source 46, such as a battery, embedded in, or connectable to, the housing. The battery 46 may provide power to the PCB 62, a feedback indicia 64 (e.g., LED) and/or the mobile device 8, the latter through the connector 32 and/or by way of induction. The PCB 62 may include a processor, such as a microprocessor. The holder 6 may include other user interfaces, such as buttons 70, 72, 74, that control other functions, and may overlie and mechanically interface with various interfaces, such as buttons, on the mobile device. In one embodiment, the activation interface does not overlie or mechanically interface with any activation interface on the mobile device.

In one embodiment, the base portion 20 of the housing has a window 80 that is positioned to be aligned with the camera 12 of the mobile device when supported by the holder 6 such that the camera 12 is not obscured by the base portion 20. The holder may include feedback indicia 64 configured to advise the user about the status of the mobile device. In one embodiment, the feedback indicia 64 may be an LED. The LED may be positioned in a visible location easily viewed by the user and other persons facing the user. In one embodiment, the LED at least partially surrounds the activation interface 60, and in one embodiment, completely surrounds the activation interface, thereby forming a ring. The LED may indicate the state of the device (recording, not recording, standby mode, etc). For example, and without limitation, the operating mode may include: (1) Blinking red: Recording or recovering an interrupted video, or booting up or powering down; (2) Blinking green: Buffering mode; (3) Solid red: Error state or booting up or powering down. Battery level may be indicated by (1) Green: Battery is greater than 90% charged; (2) Yellow: Battery is between 11% and 89% charged, (3) Red: Battery is less than 10% charged. Recording state may be indicated by: (1) Blinking red and Triad: with recording started by a remote signal broadcast or gunshot detection. Other status may include (1) Blinking purple: livestreaming; (2) Blinking blue: Microphone off or pairing mode; (3) Spinning white: Network error; (4) Spinning yellow: Uploading video. The operator may turn off the LED lights, sounds, and vibrations so as to run in a stealth mode.

The programmable interfaces 70, 72, 74, or buttons, may be located on the side wall(s) of the holder, and may provide the function of calling for immediate help, start livestreaming, or going into stealth mode.

The bottom wall of the housing may include a port 88 configured to receive an auxiliary connector 50 configured to transmit data and/or power to the holder. The port 88 may be electrically connected to the PCB 62 and/or connector 32, enabling the connector to further transmit power and/or data from the auxiliary connector 50 to the mobile device 8.

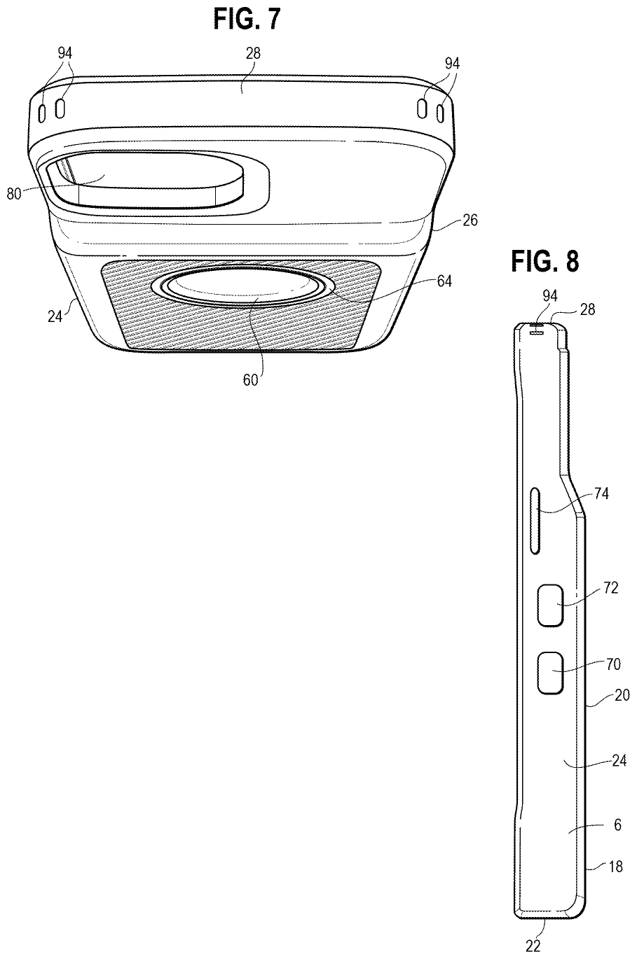

The holder may include a body engaging component 90 coupled to the housing 18, wherein the body engaging component is configured to be connected to user. The body engaging component may be configured as a lanyard coupled to the housing. In one embodiment, the ends of the lanyard include clips that engage, or the lanyard is threaded through, a pair of openings 94 at each corner of the housing, for example at the junction between the top and side walls, as shown in FIG. 7.

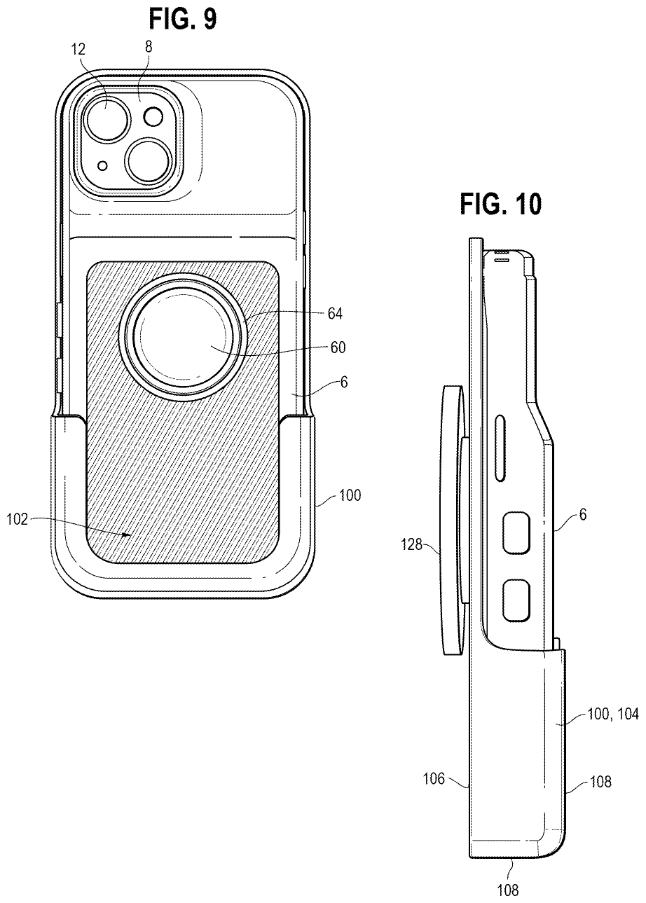

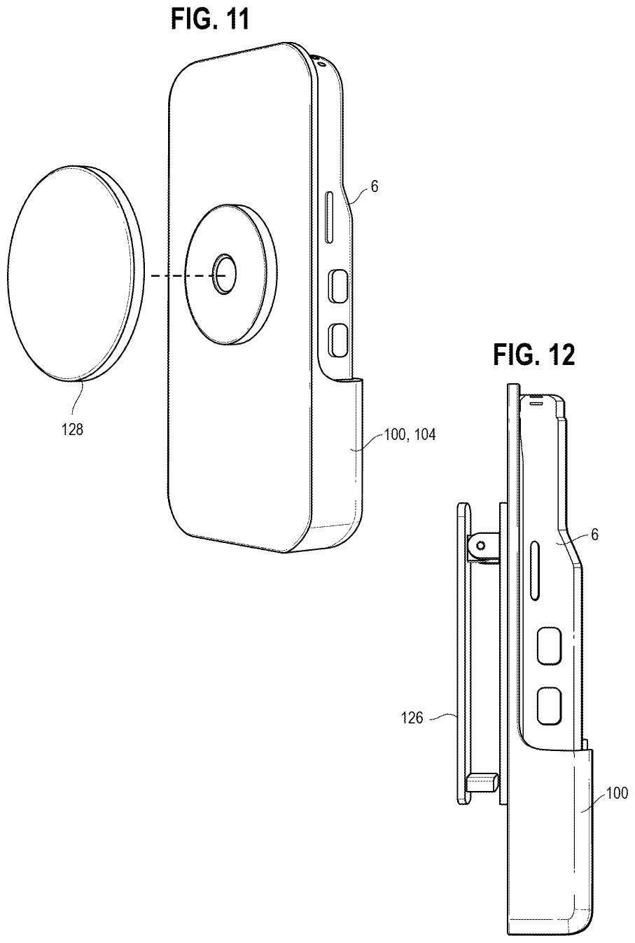

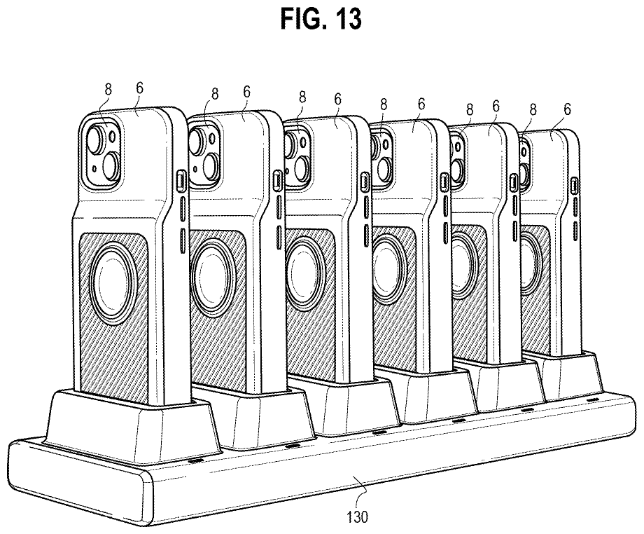

In another embodiment, shown in FIGS. 9-13, the body engaging component may include an auxiliary holder 100 defining a cavity 102 shaped to receive the holder 6 and mobile device 8. The auxiliary holder includes an auxiliary housing 104 having a base portion 106 overlying the screen of the mobile device, which helps protect the screen, a bottom wall 108 and a pair of side walls 110. The base portion, bottom wall and side walls define the cavity 102 or pocket that receives a bottom portion of the holder 6 and mobile device 8. The auxiliary holder 100 and holder 6 may engage each other by way of detents or tabs to prevent an inadvertent separation thereof. In one embodiment, the auxiliary holder 100 includes one or more of a clip 126 and/or magnet 128, which may secure the auxiliary holder 100, holder 6 and mobile device 8 to a user. The magnet 128 may include a pair of magnets that are positioned on opposite sides of and engage a layer of the user's clothing. As shown in FIG. 13, a plurality of holders 6 carrying mobile devices 8 may be positioned in a docking/charging station 130, and be connected via the port 88 and connector 50 for charging.

A recording system for actuating the camera 12 on the mobile device 8 includes the holder 6 and the mobile device 8, wherein the mobile device is engaged by the at least one engaging feature with a rear surface of the mobile device positioned against an interior surface of the base portion. The screen 16 of the mobile device faces away from the holding portion, wherein the camera 12 of the mobile device faces but is not obscured by the base portion 20, as it is aligned with the window. The auxiliary holder 100, defining the cavity shaped to receive the holder and mobile device, covers and protects the screen 16 of the mobile device.

In operation, one method of recording a user interaction includes positioning a mobile device 8 having a camera 12 on the holder 6, wherein the holder and mobile device are in communication, attaching the holder 6 and mobile device 8 to the user, actuating an activation interface 60 on the holder, and sending a signal to the mobile device 8 to turn on the camera 12. The method may further include engaging the mobile device 8 with the connector 32, and transmitting the signal through the connector 32. The method further includes providing feedback indicia to the user about the status of the camera, for example by illuminating an LED 64. In a set-up mode, a user may insert the mobile device 8 into the cavity 34 of the holder, open a quick record app, and program the various button 70, 72, 74 functions/usages. In use, the operator 10 simply presses the activation interface 60, or quick record button, on the front of the holder 6 to begin recording.

The holder, system and methods of use may be used by law enforcement and other first responders, retail associates, game hunters, tattoo artists, extreme sport enthusiasts, cyclists, hikers, wildlife observes, and in construction and transportation, including airline attendants, conductors and vehicle operators.

In one implementation, the holder 6 includes circuitry for transmitting raw sensor data and/or signals in real-time to the mobile device 8. The mobile device may implement processing software to interpret and act on the raw data, for example by turning on the camera 12 and microphone 14 and/or alerting authorities. The mobile device 8 may include software that filters and processes the raw sensor data and outputs the relevant status information contained in the raw sensor data to the display 16 on the smart phone, or activate various functions of the mobile device. The mobile device may alternatively use its local resources to contact a remote database or server to retrieve processing instructions or to forward the raw sensor data, including video capture, for remote storage, processing and interpretation, and/or to receive the processed and interpreted sensor data back from the remote server for display. In one embodiment, the mobile device is connected via an App so that when activated the data is sent to cloud storage, and/or stored locally on the device. In this way, if the device is taken from the user/wearer, for example by the person(s) being recorded, the video images and/or other sensor data is automatically preserved and stored in the remote storage device.

Proactive operations relating to the mobile device may be actively managed and controlled. In yet other implementations, real-time data gathered in the mobile device, such as video and/or audio content, may be relayed to a remote server 130 and may trigger the remote server to track down and notify a management and/or first responder regarding a problem recognized by the mobile device. The remote server may generate alerts to send via text, email or other electronic communication medium to the user, or third parties.

The electronic circuitry in the holder, the local computing device and/or the remote server discussed above, may include some or all of the capabilities of a computer in communication with a network and/or directly with other computers. The computer may include a processor, a storage device, a display or other output device, an input device, and a network interface device, all connected via a bus. A power source, such as a battery, is coupled to and powers the computer. The computer may communicate with the network. The storage device represents one or more mechanisms for storing data. For example, the storage device may include a computer readable medium such as read-only memory (ROM), RAM, non-volatile storage media, optical storage media, flash memory devices, and/or other machine-readable media. In other embodiments, any appropriate type of storage device may be used.

The battery or other power supply for any controller circuitry, sensors, gauges and switches may be rechargeable or removable in different embodiments of smart devices described herein. In order to minimize battery drain, certain sensors may be configured for a predetermined sampling frequency rather than a continuous measurement mode. Also, the circuitry on the smart device may only activate upon the detection of a particular event and may automatically turn off after a predetermined period from the initial trigger or after sensed idle period for the device.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A holder for holding and controlling a mobile device capable of capturing an image, the holder comprising:
a housing comprising:
a base portion having an activation interface, wherein the base portion is configured to be positioned adjacent a rear surface of the mobile device;
at least one engaging feature extending from the base portion, wherein the engagement feature is configured to engage at least one of a side, bottom or top of the mobile device; and
a connector configured to transmit data and/or power to the mobile device from the holder.

2. The holder of claim 1 wherein the at least one engaging feature comprises a bottom wall, and wherein the connector comprises an insert portion extending from the bottom wall, wherein the insert portion is spaced apart from an interior surface of the base portion, wherein the insert portion is configured to be received in a port of the mobile device.

3. The holder of claim 2 wherein the at least one engaging feature further comprises a pair of side walls and a top wall, wherein the base portion, side walls, top wall and bottom wall define a cavity configured to receive a body of the mobile device.

4. The holder of claim 3 wherein the base portion comprises a window positioned to be aligned with a camera on the mobile device when supported by the holder.

5. The holder of claim 1 wherein the activation interface comprises a button.

6. The holder of claim 5 further comprising feedback indicia configured to advise a user about a status of the mobile device.

7. The holder of claim 6 wherein the feedback indicia comprises an LED.

8. The holder of claim 7 wherein the LED at least partially surrounds the activation interface.

9. The holder of claim 1 further comprising a body engaging component coupled to the housing, wherein the body engaging component is configured to be connected to a user.

10. The holder of claim 9 wherein the body engaging component comprises a lanyard coupled to the housing.

11. The holder of claim 9 wherein the body engaging component comprises an auxiliary holder defining a cavity shaped to receive the housing.

12. The holder of claim 11 wherein the auxiliary holder comprises one or more of a clip and/or magnet.

13. The holder of claim 1 further comprising a power source carried by the housing.

14. The holder of claim 1 further comprising a printed circuit board embedded in the housing, wherein the printed circuit board is in communication with the connector.

15. The holder of claim 2 wherein the bottom wall further comprises a port configured to receive an auxiliary connector configured to transmit data and/or power to the holder.

16. A recording system for actuating a camera on a mobile device comprising:
the holder of claim 1; and
the mobile device, wherein the mobile device is engaged by the at least one engaging feature with a rear surface of the mobile device positioned against an interior surface of the base portion, wherein a screen portion of the mobile device faces away from the base portion, wherein the camera of the mobile device faces but is not obscured by the base portion.

17. The recording system of claim 16 further comprising an auxiliary holder defining a cavity shaped to receive the holder and the mobile device.

18. The recording system of claim 17 wherein the auxiliary holder comprises one or more of a clip and/or a magnet.

19. A method of recording a user interaction comprising:
positioning a mobile device comprising a camera on a holder, wherein the holder and mobile device are in communication;
attaching the holder and mobile device camera to the user;
actuating an activation interface on the holder; and
sending a signal from the holder to the mobile device to turn on the camera.

20. The method of claim 19 wherein the holder comprises a connector, wherein positioning the mobile device on a holder comprises engaging the mobile device with the connector, and wherein sending the signal to the mobile device comprises transmitting the signal through the connector.

21. The method of claim 19 further comprising providing feedback indicia to the user about the status of the camera.

22. The method of claim 21 wherein providing the feedback indicia comprises illuminating an LED.
